(19) United States
(12) Patent Application Publication
(10) Pub. No.: US 2004/0196366 A1
(43) Pub. Date: Oct. 7, 2004

(54) Method and system for monitoring livestock

(76) Inventor: William S. Thiel, Oconomowoc, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/406,167

(22) Filed: Apr. 3, 2003

(51) Int. Cl. H04N 7/18

(52) U.S. Cl. 348/143; 348/89

(57) ABSTRACT

A method and a system for monitoring livestock is adaptable for use in settings where the animals are kept in stationary structures, such as barns or other outbuildings, and in settings where the animals are being transported by means of a livestock trailer or the like. The method and system of the present invention provides for three primary elements. The first element is the visual receptor element. It includes a camera, a power adapter, mounting hardware for the camera, and cable for connecting those components to the second element, a transmitter and power adapter. The third element is a receiver, a power adapter and additional cables. In the preferred embodiment of the device used with the method and system of this invention, the receiver includes an integral monitor that is used for viewing purposes.

### FIELD OF THE INVENTION

This invention relates generally to surveillance systems and to methods for using such systems. More particularly, it relates to a method and to a system for monitoring livestock while such livestock is situated in an out building or is being transported by mobile trailer.

### BACKGROUND OF THE INVENTION

Since the earliest days of mankind, we have sought to maintain vigil over our livestock. Shepherds have kept watch over their sheep for thousands of years, using sheep dogs to alert the shepherds to any impeding danger that might befall members of the flock. In the early days of this country, the western plains saw cowboys ride circles around horses and cattle to keep them out of harm's way. Although the principle remains the same today, technology has had a hand in simplifying our lives in every aspect of it. To this end, the method and system of the present invention utilizes modern electrical components to assist owners in maintaining a watchful eye over their livestock. In the experience of this inventor, the most important time that livestock need to be monitored is when they are out of the direct line of sight of their owner. That is, the livestock are physically located in a building or other structure separate and apart from the dwelling of their human owners. This could be a pen, a shed, or a barn, for example, where part of the building or its physical structure, or some other like barrier, blocks the view of the human owner. This could also be a trailer wherein the stock are being transported and the physical structure of the towing vehicle as well as the physical structure of the towed trailer blocks virtually any clear view of the livestock.

What is needed is a method and a system whereby the human owners of livestock can observe and visualize their stock to ensure the well being of the stock during confinement and transport. What is also needed is such a method and system that is usable in settings where the structures in which the livestock are maintained are made of metallic material, which material has a tendency to interfere with the transmission of electromagnetic waves through such structures. What is also needed is such a method and system that is useable in either a stationary setting or in one wherein the livestock are being transported from one location to another.

### BRIEF SUMMARY OF THE INVENTION

Accordingly, the present invention provides a method and a system for monitoring livestock that is adaptable for use in settings where the animals are kept in stationary structures, such as barns or other outbuildings, and in settings where the animals are being transported by means of a livestock trailer or the like. The method and system of the present invention provides for three primary elements. The first element is the visual receptor element. It includes a camera, a power adapter, mounting hardware for the camera, and cable for connecting those components to the second element, a transmitter and power adapter. The third element is a receiver, a power adapter and additional cables. In the preferred embodiment of the device used with the method and system of this invention, the receiver includes an integral monitor that is used for viewing purposes.

The foregoing and other features of the method and system of the present invention will be apparent from the detailed description that follows.

### BRIEF DESCRIPTION OF THE DRAWINGS

FIG. 1 is an elevational view and schematic representation of a home and barn with which the method and system of the present invention would be used.

FIG. 2 is an enlarged and partially sectioned view of the home and barn illustrated in FIG. 1.

FIG. 3 is a further enlarged view of the monitor portion that is utilized with the method and system of the present invention shown displaying a portion of the contents of the barn.

FIG. 4 is an elevational view of a truck and trailer combination with which the method and system of the present invention would be used.

### DETAILED DESCRIPTION

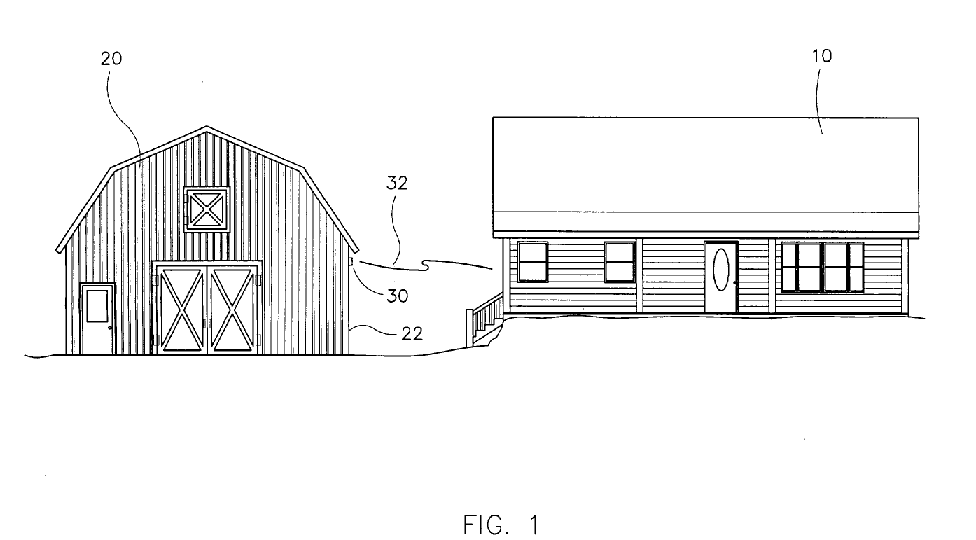

Reference is now made to the drawings wherein like numbers refer to like elements throughout. FIG. 1 illustrates a house 10 and a barn 20 with which the method and system of the present invention is intended to be used. It is to be understood that the precise type and style of structure is not a limitation of the present invention. It is also to be understood that the distance between the two structures 10, 20 is not a limitation of the present invention. The buildings 10, 20 shown are for illustrative purposes only and the distance between them could be greatly varied without deviating from the scope of the present invention. As shown, an outer wall 22 of the barn 20 has mounted to it a wireless audio-video (AV) transmitter 30, the purpose and function of which will be apparent shortly. The AV transmitter 30 is of the type that is electrically actuated and that generates and transmits an electromagnetic wave 32, a portion of which is propagated between the barn 20 and the house 10, and is capable of transmitting at a number of different frequencies or wavelengths. In the preferred embodiment of the present invention, the wireless AV transmitter 30 is of any commercially available type, the precise frequency of operation not being a limitation of the present invention. The AV transmitter 30 includes a built-in antenna (not shown) for transmission of the wave 32. Accordingly, placement of the AV transmitter 30 to the exterior surface 26 of the wall 22 will be significant for reasons given later in this detailed description.

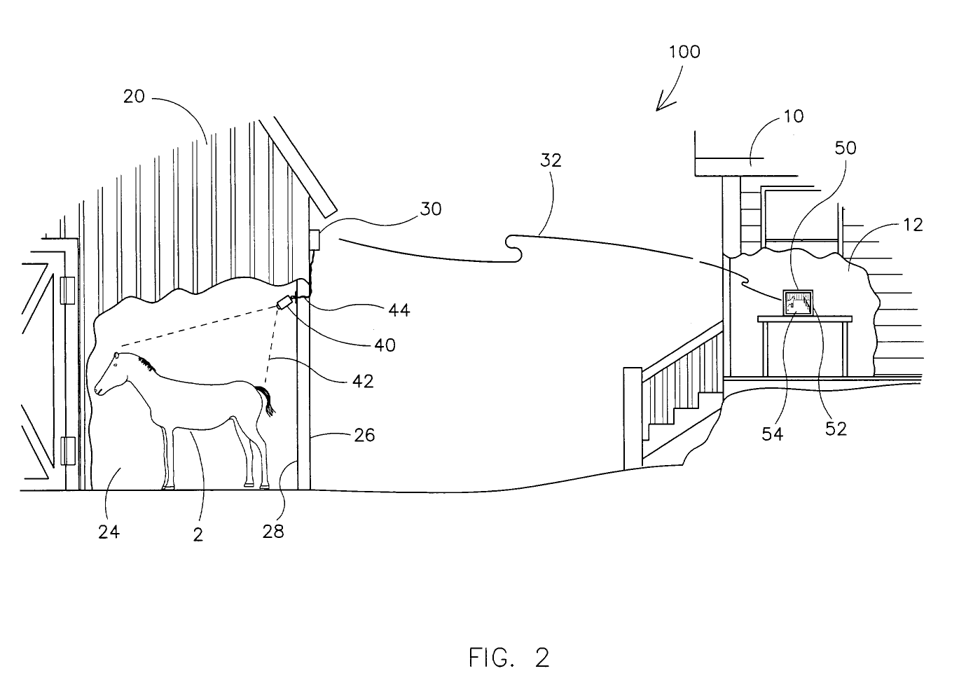

Referring now to FIG. 2, it shows an enlarged and cut-away view of an interior portion 12 of the house 10 and an interior portion 24 of the barn. Contained safe and secure within that interior portion 24 of the barn 20 is a part of the user's livestock which, in this case, is shown as being a horse 2. As was also shown in FIG. 1, the wireless AV transmitter 30 is mounted to the exterior surface 26 of the barn wall 22. Mounted to the interior surface 28 of the barn wall 22 is a video camera 40. The video camera 40 captures a field of view 42 within the interior portion 24 of the barn 20. As shown in FIG. 2, that field of view 42 includes the horse 2 or any other animal that might wander into the field of view 42 of the camera 40. The exact field of view 42 being captured is not a limitation of the present invention. The precise method of mounting of the transmitter 30 and the camera 40 to the wall 22 is not a limitation of the present invention either. Furthermore, the precise location of the transmitter 30 and camera 40 is not a limitation of the present invention. Nor is it necessary that the transmitter 30 and camera 40 be mounted to the same wall 22. In application, the camera 40 could be mounted to almost another structure within the barn 20, which structure could be described as something other than a wall 22. It is necessary, however, that the transmitter 30 be mounted to the exterior surface 26 of the barn 20. The wireless AV transmitter 30 and the camera 40 are electrically connected by means of an electrical cord 44. Both the transmitter 30 and the camera 40 are electrically actuated and must include an electrical source (not shown). This electrical source could be an AC current from a typical electrical outlet or a DC current from a battery pack or the like. The precise method of electrical actuation is not a limitation of the present method and system. In the preferred embodiment, an AC electrical outlet would is used.

Upon transmission of the electromagnetic wave 32 from the wireless AV transmitter 30, a portion of the wave 32 is captured by a wireless receiver 50 that is utilized with the method and system of the present invention. As was true of the camera 40 and transmitter 30, the wireless receiver 50 is electrically actuated and must include an electrical source (not shown). This electrical source could be an AC current from a typical home electrical outlet or a DC current from a battery pack or the like. The precise method of electrical actuation is not a limitation of the present method and system. In the preferred embodiment, the wireless receiver shown in FIG. 2 utilizes an AC current.

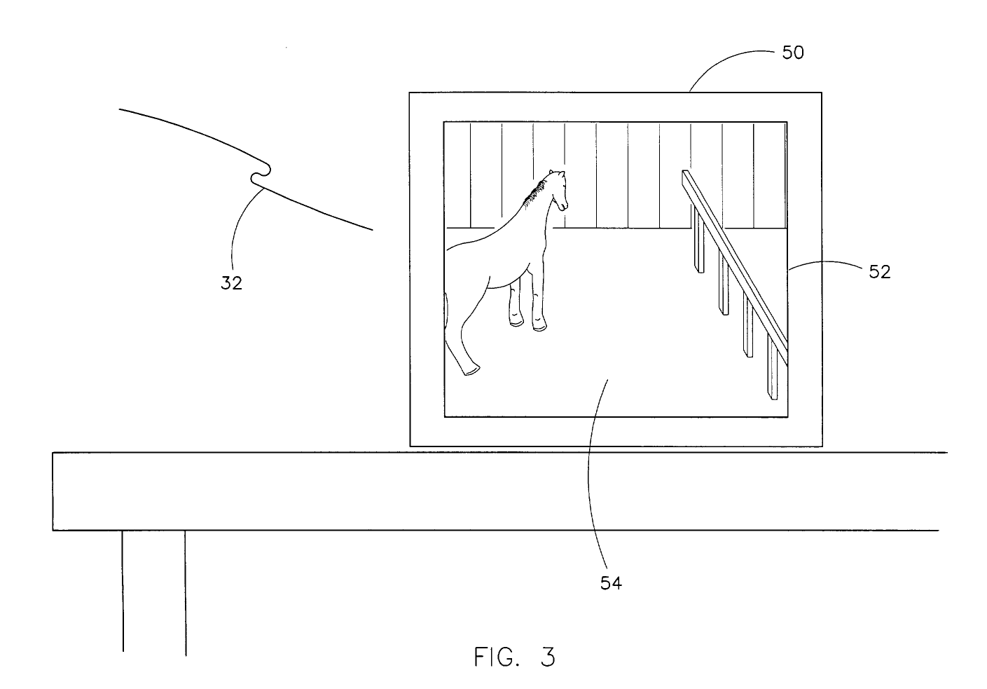

As shown in FIG. 2, the wireless receiver 50 includes an integral monitor 52 that displays 54 the field of view 42 as viewed by the camera 40. See also, FIG. 3. In the preferred embodiment, the wireless receiver 50 includes a liquid crystal display (LCD) 52. It is to be understood, however, that the wireless receiver 50 could also be a receiver only device with its audio-visual output being connected to a conventional monitor or even to a television set (not shown). These embodiments are included within the scope of the present invention.

In reviewing the foregoing, it will be seen that the monitoring system of the present invention, generally identified 100, includes three primary elements. The first element is the visual receptor element. It includes the camera 40, a power adapter, mounting hardware for the camera 40, and a cable 44 for connecting those components to a second element. The second element is the transmitter 30 and its power adapter. The third element of the monitoring system 100 is the receiver 50, a power adapter and additional cables. In the preferred embodiment of the device used with the system of this invention, the receiver 50 includes an integral monitor 52 that is used for viewing purposes. In application, the user mounts the camera 40 within a structure 20 such that a desired field of view 42 is obtained. The wireless AV transmitter 30 is mounted outside of the structure 20. Because the structure 20 may be a metal shed or metal barn, for example, the transmitter 30 is mounted to the exterior 22 of the structure 20 so as to eliminate any possible insulating effect that might otherwise be created and dampen the transmission of electromagnetic waves 32 from the transmitter 30 and its built-in antenna (not shown). It is known that metal structures, and particularly metal structures having a continuous metal skin can prevent the transmission of electromagnetic waves generated from within such structures. Placement of the transmitter 30, which transmitter 30 includes a built-in antenna as previously described, to the exterior of that skin or structure eliminates that interference. The transmitter 30 and the camera 40 are then wired or connected together by a wire creating an electrically continuity between them. A wireless receiver 50 is then located in a remote location such that the transmission of electromagnetic waves 32 from the transmitter 30 are received by the receiver 50. The field of view 42 originating in the first structure 20 is then duplicated electronically on the display monitor 52 of the receiver 50 whereby the user can monitor his or her livestock 2 as such is desired or required. In the event that the receiver 50 does not include an integral display monitor 52, the audio-visual output of the receiver 50 could be connected to a conventional monitor or to a television set (not shown) for remote viewing of the field of view 42 and still come within the scope of the present invention.

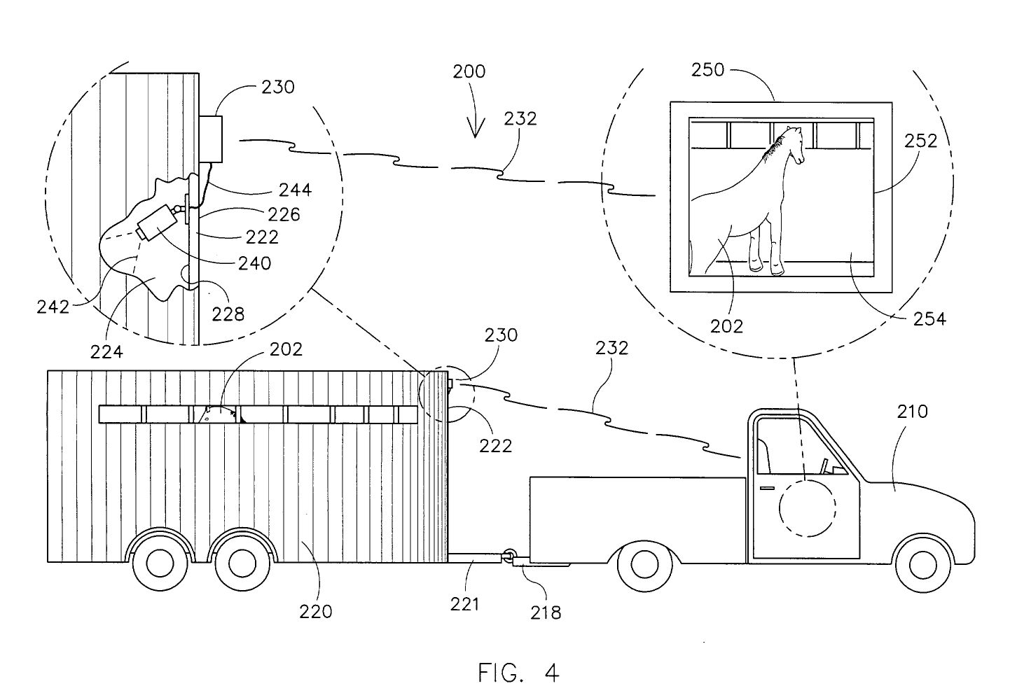

In an alternative embodiment of the method and system of the present invention, the monitoring system, generally identified 200, is utilized in a mobile setting. As shown in FIG. 4, a motor vehicle 210 and a pull-behind trailer 220 replace the house 10 and barn 20 of the stationary embodiment previously described. It is to be understood that the precise type and style of either the vehicle 210 or the trailer 220 is not a limitation of the present invention. The vehicle 210 and trailer 220 shown are for illustrative purposes only. It is also to be understood that the distance between the two is not a limitation of the present invention, although the practical limitation here is that the hitch 221 and tow bar 218 are of some finite length and cannot be as limitless as the first embodiment. As shown, an outer wall 222 of the barn 220 has mounted to it a wireless transmitter 230, the purpose and function of which is identical to that of the first embodiment. As before, the transmitter 230 is of the type that includes a built-in antenna (not shown). The transmitter 230 is electrically actuated and generates and transmits an electromagnetic wave 232, a portion of which is propagated between the trailer 220 and the vehicle 210, and is capable of transmitting at a number of different frequencies or wavelengths. In this second preferred embodiment of the present invention, the wireless AV transmitter 230 is of any commercially available type, the precise frequency of operation not being a limitation of the present invention.

FIG. 4 also shows an enlarged and cut-away view of an interior portion 224 of the trailer 220. Contained within that interior portion 224 of the trailer 220 is at least one horse 202. The wireless AV transmitter 230 is mounted to the exterior surface 226 of the trailer wall 222. Mounted to the interior surface 228 of the trailer wall 222 is a video camera 240. The video camera 240 captures a field of view 242 within the interior portion 224 of the trailer 220. As shown in FIG. 4, that field of view 242 includes the horse 202 or any other animal that might be housed in the trailer 220 and wander into the field of view 242 of the camera 240. As was true of the first embodiment, the exact field of view 242 being captured is not a limitation of the present invention. The precise method of mounting of the transmitter 230 and the camera 240 to the wall 222 is not a limitation of the present invention either. Furthermore, the precise location of the transmitter 230 and camera 240 relative to the trailer 220 is not a limitation of the present invention. Nor is it necessary that the transmitter 230 and camera 240 be mounted to the same wall 222. In application, the camera 240 could be mounted to another structure within the trailer 220, which structure could be described as something other than a wall 222. It is necessary, however, that the transmitter 230 be mounted to the exterior surface 226 of the trailer 220 for reasons previously discussed. The wireless AV transmitter 230 and the camera 240 are electrically connected by means of an electrical cord 244. Both the transmitter 230 and the camera 240 are electrically actuated and must include an electrical source (not shown). This electrical source could be a DC current from an electrical cable running through the hitch 221 of the trailer 220 from the vehicle 210. The precise method of electrical actuation is not a limitation of the present method and system.

Upon transmission of an electromagnetic wave 232 from the wireless transmitter 230, a portion of the wave 232 is captured by the receiver 250 that is utilized with the method and system of the present invention. As was true of the camera 240 and transmitter 230, the wireless receiver 250 is electrically actuated and must include an electrical source (not shown). This electrical source would also a DC current running directly from the vehicle's battery or, for example, through a cigarette lighter adapter. The precise method of electrical actuation is not a limitation of the present method and system. The wireless receiver 250 includes an integral monitor 252 that displays 254 the field of view 242 as viewed by the camera 240. Because the trailer 220 is typically of metal construction, the transmitter 230 is mounted to the exterior 222 of the trailer 220 so as to eliminate any possible insulating effect that might otherwise be created and which would otherwise dampen the transmission of electromagnetic waves 232 from the transmitter 230. As was true of the metal barn or shed, metal structures, and particularly metal trailers having a continuous metal skin can, in the experience of this inventor, prevent the transmission of electromagnetic waves generated from within such structures. Placement of the wireless transmitter 230, together with its built-in antenna (not shown), to the exterior of that skin or structure eliminates that interference.

Based on the foregoing, it will be apparent that there has been provided a new and useful method and system for monitoring livestock that is adaptable for use in settings where the animals are kept in stationary structures, such as barns or other outbuildings, and in settings where the animals are being transported by means of a livestock trailer or the like. The method and system of the present invention requires the utilization of three primary elements. The first element is the visual receptor element. It includes a camera, a power adapter, mounting hardware for the camera, and cable for connecting those components to the second element, a transmitter and power adapter. The third element is a receiver, a power adapter and additional cables. In the preferred embodiment of the device used with the method and system of this invention, the receiver includes an integral monitor that is used for viewing purposes.

The principles of this invention being described in accordance with the foregoing, I claim as my invention the following:

1. A system for monitoring livestock contained within a structure which comprises
a visual receptor element located inside of the structure,
a transmitter element located outside of the structure, and
a receiver element located remote of the structure,
whereby livestock contained within the structure may be viewed remotely by a user.

2. The livestock monitoring system of claim 1 wherein the visual receptor element is a video camera and the transmitter element is a wireless audio-visual transmitter having a built-in antenna, said camera and transmitter being electrically connected.

3. The livestock monitoring system of claim 2 wherein the receiver is a wireless audio-visual receiver.

4. The livestock monitoring system of claim 3 wherein the receiver includes a video display monitor.

5. The livestock monitoring system of claim 4 wherein the wireless transmitter is mountable to the exterior surface of a metal structure and the camera is mountable to the interior of the metal structure.

6. The livestock monitoring system of claim 5 wherein the camera is functionally adapted to visually capture a field of view within the structure and electronically transmit the field of view to the wireless transmitter.

7. The livestock monitoring system of claim 6 wherein the wireless transmitter is functionally adapted to transmit an electromagnetic wave that contains the field of view information within it.

8. The livestock monitoring system of claim 7 wherein the wireless receiver is functionally adapted to receive the electromagnetic wave generated by the transmitter and is further provided with a video display for visually displaying the field of view information captured by the camera.

9. The livestock monitoring system of claim 8 wherein the metal structure is a building constructed substantially of metal material and the monitor is situated at a location outside of the building.

10. The livestock monitoring system of claim 9 wherein the metal structure is a trailer constructed substantially of metal material and the monitor is situated in a vehicle that is towing the trailer.

11. A method for monitoring livestock which comprises the steps of
providing a visual receptor element,
providing a transmitter element, and
providing a receiver element,
whereby livestock may be viewed remotely by a user.

12. The livestock monitoring method of claim 11 wherein the visual receptor element providing step includes providing a video camera and the transmitter element providing step includes providing a wireless audio-visual transmitter having a built-in antenna, said camera and transmitter being electrically connected.

13. The livestock monitoring method of claim 12 wherein the receiver providing step includes providing a wireless audio-visual receiver.

14. The livestock monitoring method of claim 13 wherein the receiver providing step includes providing a receiver that has a video display monitor.

15. The livestock monitoring method of claim 14 wherein the wireless transmitter providing step includes providing a transmitter that is mountable to the exterior surface of a metal structure and the camera providing step includes providing a camera that is mountable to the interior of the metal structure.

16. The livestock monitoring method of claim 15 wherein the camera is functionally adapted to visually capture a field of view within the structure and is further adapted to electronically transmit the field of view to the wireless transmitter.

17. The livestock monitoring method of claim 16 wherein the wireless transmitter is functionally adapted to transmit an electromagnetic wave.

18. The livestock monitoring method of claim 17 wherein the wireless receiver is functionally adapted to receive the electromagnetic wave generated by the transmitter and is further provided with a video display of the field of view captured by the camera.

19. The livestock monitoring method of claim 18 wherein the metal structure comprises a building constructed of metal material and the monitor is situated at a location outside of the building.

20. The livestock monitoring method of claim 19 wherein the metal structure comprises a trailer constructed of metal material and the monitor is situated within a vehicle that is towing the trailer.
